(19) United States
(12) Patent Application Publication
(10) Pub. No.: US 2026/0319147 A1
(43) Pub. Date: Oct. 15, 2026

(54) METHOD OF FABRICATING A MULTI-STEP GRATING WITH VARIABLE DEPTH

(71) Applicant: Applied Materials, Inc., Santa Clara, CA (US)

(72) Inventors: Wenhui WANG, San Jose, CA (US); Lei JIANG, San Ramon, CA (US); Zefang WANG, Santa Clara, CA (US); Chia-Wei HUANG, Sunnyvale, CA (US); Chan Juan XING, San Jose, CA (US); Elise LAFFOSSE, Santa Clara, CA (US); Yongan XU, Santa Clara, CA (US)

(21) Appl. No.: 19/642,382

(22) Filed: Apr. 8, 2026

Related U.S. Application Data
(60) Provisional application No. 63/785,992, filed on Apr. 9, 2025.

(51) Int. Cl. G02B 5/18; F21V 8/00

(52) U.S. Cl. CPC G02B 5/1857; G02B 5/1828; G02B 6/0016

(57) ABSTRACT

Methods for forming variable-depth blazed gratings are disclosed. In one embodiment, a grating layer is patterned using one or more hardmask layers and resist layers having thickness variations corresponding to a desired blazed profile. Sequential etching steps are performed to form multiple stepped structures in the grating layer, wherein different steps have different depths and collectively approximate a variable-depth blazed grating. In some embodiments, hardmask layers with different etch selectivities are used to transfer resist thickness variations into the grating layer with increased depth control. The disclosed methods enable precise formation of multi-step grating profiles suitable for optical applications. Waveguides incorporating such gratings, including waveguides for augmented-reality and virtual-reality display systems, are also disclosed.

### CROSS-REFERENCE TO RELATED APPLICATIONS

This application claims the benefit of U.S. Provisional Patent Application Serial No. 63/785,992, filed April 9, 2025, which is incorporated by reference herein in its entirety.

### BACKGROUND

### Field

Embodiments of the present disclosure generally relate to methods of forming waveguides for augmented, virtual, and mixed reality. More specifically, embodiments described herein provide for waveguides and methods of forming waveguides having at least one grating with staircase structures.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

In many virtual-reality, augmented-reality, and mixed-reality display systems, optical waveguides are used to deliver image light from a display engine to a user’s eye in a compact form factor suitable for head-mounted displays. An optical waveguide generally includes a transparent substrate configured to receive light from a light source or microdisplay, guide that light through the substrate by internal reflection, and redirect the light toward the user’s eye using one or more optical coupling structures. While waveguides enable lightweight, compact, and visually integrated AR/VR displays, their design and manufacture present significant challenges, including optical efficiency, uniformity, field of view, color performance, and the precision and scalability of waveguide fabrication processes.

Accordingly, what is needed in the art are improved waveguides and methods of forming waveguides.

### SUMMARY

In one embodiment, a method forming a variable depth blazed grating is disclosed. The method includes forming a hardmask pattern over a grating layer. The hardmask pattern includes hardmask portions. The method further includes forming a first resist over the hardmask pattern and the grating layer. The first resist has a first etch profile with a thickness variation along a length of the grating layer corresponding to the variable depth blazed grating. The method includes etching the grating layer to form first steps having first depths in the grating layer, wherein at least two of the first depths are different. The method further includes forming a photoresist pattern over the grating layer. The photoresist pattern includes photoresist portions that are disposed over the hardmask portions and in the first steps, wherein first portions of each hardmask portion are exposed. The method includes etching the first portions of each hardmask portion and forming a second resist over the hardmask pattern and the grating layer. The second resist has a second etch profile with a second thickness variation along the length of the grating layer corresponding to the variable depth blazed grating. The method further includes etching the grating layer to form second steps having second depths in the grating layer, wherein at least two of the second depths are different and the first depths of the first steps are increased.

In another embodiment, another method of forming a variable depth blazed grating is disclosed. The method includes forming a first hardmask layer over a grating layer. The first hardmask layer has a first hardmask etch selectivity. The grating layer has a grating layer etch selectivity. The method includes forming a first resist over the first hardmask layer. The first resist has a first etch selectivity and a first etch profile with a thickness variation along a length of the grating layer corresponding to the variable depth blazed grating. The method further includes etching the first hardmask layer to form a thickness variation in the first hardmask layer along the length of the grating layer and forming a second hardmask layer over the first hardmask layer. The second hardmask layer has a uniform thickness and a second hardmask etch selectivity. The method includes etching the first hardmask layer, the second hardmask layer, or both to form a plurality of hardmask structures. The hardmask structures include a first step having a first depth and a second step having a second depth. The method further includes etching the grating layer to form a plurality of structures in the grating layer. The structures include the first step having the first depth and the second step having the second depth.

In yet another embodiment, a waveguide is disclosed. The waveguide includes a substrate and a grating layer disposed over the substrate. The waveguide further includes a grating formed in or on the grating layer. The grating includes a plurality of structures. Each structure includes a structure depth different from each other structure. Each structure further includes a first step having a first depth. The first depth of a first structure is different than the first depth of a second structure. The structure also includes a second step having a second depth different from the first depth. The second depth of the first structure is different than the second depth of the second structure. The first step and the second step approximate a variable depth blazed profile.

### BRIEF DESCRIPTION OF THE DRAWINGS

So that the manner in which the above recited features of the present disclosure can be understood in detail, a more particular description of the disclosure, briefly summarized above, may be had by reference to embodiments of the disclosure, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 illustrates a schematic, top view of a waveguide, according to embodiments disclosed herein.

FIG. 2 illustrates a schematic, cross-sectional view of an input coupling grating of the waveguide of FIG. 1, according to embodiments disclosed herein.

FIG. 3 illustrates a flow diagram of a method of forming a grating having two or more structures, according to embodiments disclosed herein.

FIGS. 4A-4G illustrate schematic, cross-sectional views of a substrate during the method of forming the grating having two or more structures as illustrated in FIG. 3, according to embodiments disclosed herein.

FIG. 5 illustrates a flow diagram of a method of forming a grating having two or more structures, according to embodiments disclosed herein.

FIGS. 6A-6H illustrate schematic, cross-sectional views of a substrate during the method of forming the grating having two or more structures as illustrated in FIG. 5, according to embodiments disclosed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods of forming waveguides for augmented, virtual, and mixed reality. More specifically, embodiments described herein provide for waveguides and methods of forming waveguides having at least one grating with staircase structures.

Many of the details, dimensions, angles and other features shown in the figures are merely illustrative of particular embodiments. Accordingly, other embodiments can have other details, components, dimensions, angles and features without departing from the spirit or scope of the present disclosure. In addition, further embodiments of the disclosure can be practiced without several of the details described below.

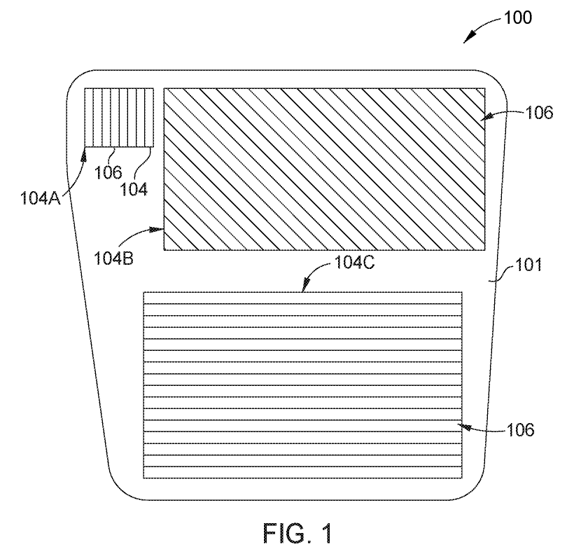

FIG. 1 illustrates a schematic, top view of a waveguide 100, according to embodiments disclosed herein. It is to be understood that the waveguide 100 described below is an exemplary waveguide. In one embodiment, waveguide 100 is an augmented reality waveguide combiner. The waveguide 100 includes substrate 101 having a plurality of structures 106. The plurality of structures 106 can be nanostructures having sub-micron dimensions, e.g., nano-sized dimensions, such as critical dimensions less than 1 μm. Regions of the plurality of structures 106 can correspond to one or more gratings 104, such as a first grating 104a, a second grating 104b, and a third grating 104c. The plurality of structures 106 may be referred to as a plurality of grating structures 106.

The substrate 101 may be formed from any suitable material, provided that the substrate 101 can adequately transmit light in a selected wavelength or wavelength range and can serve as an adequate support for the waveguide 100 described herein.

In one or more embodiments, the substrate 101 includes amorphous dielectrics, non-amorphous dielectrics, crystalline dielectrics, silicon oxide, polymers, and combinations thereof. In one or more embodiments, which may be combined with other embodiments described herein, the substrate 101 includes glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), indium tin oxide (ITO), or combinations thereof. In other embodiments, which may be combined with other embodiments described herein, the substrate 101 includes high-refractive-index glass. The high-refractive-index glass includes greater than 2 percent by weight of lanthanide (Ln), titanium (Ti), tantalum (Ta), or combination thereof. In one or more embodiments, which can be combined with other embodiments, the substrate 101 can be configured to transmit wavelengths from 100 to 3000 nanometers.

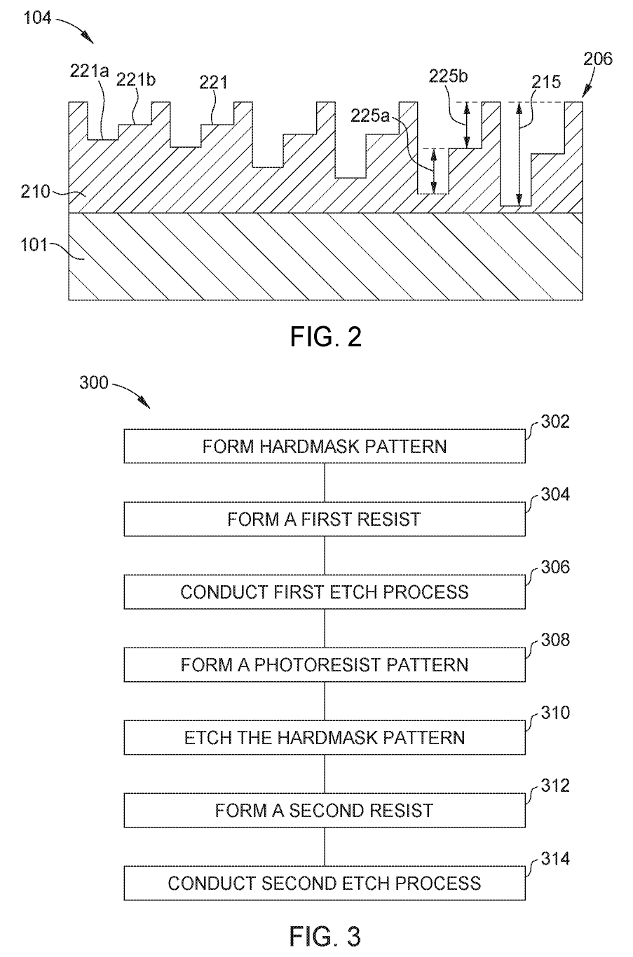

The waveguide 100 includes the first grating 104a corresponding to an incoupler, the second grating 104b corresponding to an exit-pupil-expander, and the third grating 104c corresponding to an outcoupler. The first grating 104a, the second grating 104b, and the third grating 104c may have the plurality of structures 106 formed in, on, or, over the substrate 101. In some embodiments, the gratings are formed in a device layer or a grating layer 210 (shown in FIG. 2), wherein the device layer is disposed over the substrate 101. In some embodiments, the gratings are formed in the substrate 101.

FIG. 2 illustrates a schematic, cross-sectional view of a grating 104 of the waveguide 100 of FIG. 1, according to embodiments disclosed herein. It should be appreciated that the grating in FIG. 2 could be the first grating 104a, the second grating 104b, or the third grating 104c from FIG. 1.

The structures of the grating 104 may be staircase structures 206 formed in the grating layer 210 as shown in FIG. 2. The grating 104 including the staircase structures 206 may be a blazed grating. In one or more embodiments, a metal layer is disposed over the gratings. It should be noted that each grating 104 may have the same or different depths of the staircase gratings 206. For example, the staircase structures 206 of the second grating 104b may have a different depth than the staircase structures 206 of the third grating 104c and/or the first grating 104a. In other examples, the staircase structures 206 of the second grating 104b may be the same depth as the staircase structures 206 of the third grating 104c and the first grating 104a.

The staircase structures 206 may include a plurality of steps 221. The plurality of steps 221 may approximate a blazed grating. Each staircase structure 206 may include any number of steps 221. In some embodiments, the staircase structures 206 include a first step 221a and a second step 221b. The first step 221a has a first depth 225a. The second step 221b has a second depth 225b. The depth 225 of each step 221 may be different in each staircase structure 206. For example, the first depth 225a of the first step 221a of each staircase structure 206 in the grating 104 may be a different depth. In some embodiments, the second depth 225b of the second step 221b of each staircase structure 206 in a grating 104 is a different depth.

The ratio of the first depth 225a to the second depth 225b within the same staircase structure 206 may be from about 2:1 to about 1:2. The ratio of the first depth 225a of the first step 221a of a first staircase structure 206 of one grating 104 to the first depth 225a of the first step 221a of a first staircase structure 206 of a different grating 104 may be from about 2:1 to about 1:150. In some embodiments, the ratio of the first depth 225a of the first step 221a of a first staircase structure 206 of one grating 104 to the first depth 225a of the first step 221a of a first staircase structure 206 of a different grating 104 is about 1:150. In some embodiments, the ratio of the first depth 225a of the first step 221a of a first staircase structure 206 of one grating 104 to the first depth 225a of the first step 221a of a first staircase structure 206 of a different grating 104 is about 1:25. In some embodiments, the ratio of the first depth 225a of the first step 221a of a first staircase structure 206 of one grating 104 to the first depth 225a of the first step 221a of a first staircase structure 206 of a different grating 104 is about 1:5. This ratio may apply equally to other steps 221 (e.g., 221b) within the staircase structures 206 of the two gratings 104.

Each staircase structure 206 includes a staircase depth (or structure depth) 215. The staircase depth 215 may be from about 50 nanometers (nm) to about 1000 nm. The ratio of a staircase depth 215 of a first staircase structure 206 to the staircase depth 215 of a second staircase structure 206 may be from about 4:1 to about 1:150. In some embodiments, the staircase depth 215 of each staircase structure 206 decreases along the length of the grating layer 210. In some embodiments, the staircase depth 215 of each staircase structure 206 increases along the length of the grating layer 210.

In some embodiments, the grating layer 210 may include one or more device sublayers. In one or more embodiments, the one or more sublayers (e.g., the first device sublayer and the second device sublayer) include a same material. In one or more embodiments, the one or more sublayers (e.g., the first device sublayer and the second device sublayer) include a different material. In some embodiments, the staircase structures 206 are disposed in at least the second device sublayer and at least partially in the first device sublayer. However, it should be understood that in one or more embodiments, the staircase structures 206 are disposed through as many sublayers as required. In one or more embodiments, the staircase structures 206 extend at least partially into the grating layer 210. In some embodiments, the staircase structures 206 extend at least partially through the first device sublayer and the second device sublayer. In some embodiments, the staircase structures 206 extend through the grating layer 210 and the substrate 101.

In some embodiments, the grating layer 210 is one layer. When there is one grating layer 210, the staircase structures 206 extend through the grating layer 210. In some embodiments, the staircase structures 206 are disposed through at least one sublayer (e.g., the first device sublayer) of the grating layer 210. In one or more embodiments, the staircase structures 206 include varying depths through the grating layer 210. The varying depths allow for an improved performance of the device. However, it should be understood that in one or more embodiments, the staircase structures 206 are disposed through as many sublayers as required. Incorporating staircase structures 206 in the device layer of the plurality of gratings enables a high diffraction efficiency. The high diffraction efficiency may be used for augmented reality applications.

The sublayers (e.g., the first device sublayer and the second device sublayer) include, but are not limited to, silicon oxycarbide (SiOC), titanium oxide (TiOₓ) (e.g., titanium dioxide (TiO₂)), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), titanium silicon oxide, silicon carbon-nitride (SiCN) containing materials, or combinations thereof. In some embodiments, the sublayers may be made of a silicon nitride with a different stoichiometry than Si₃N₄.

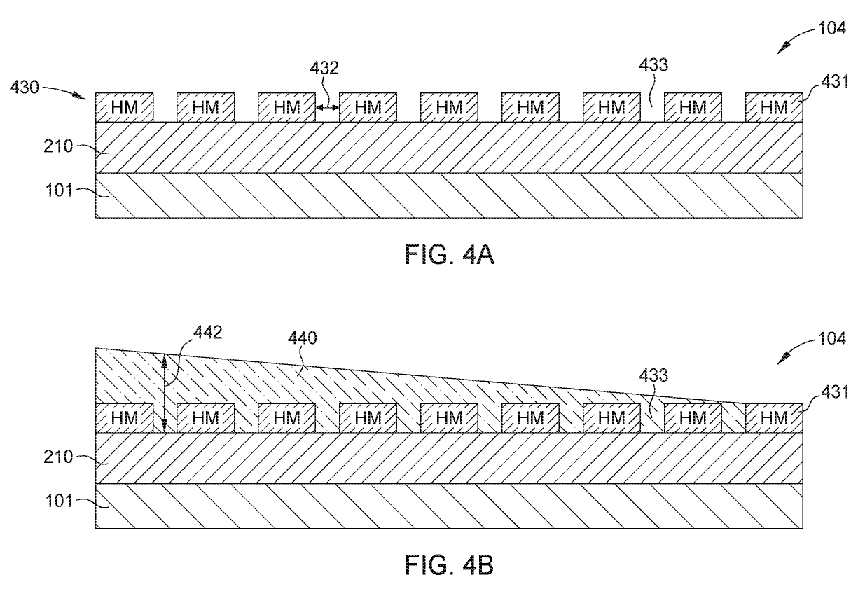

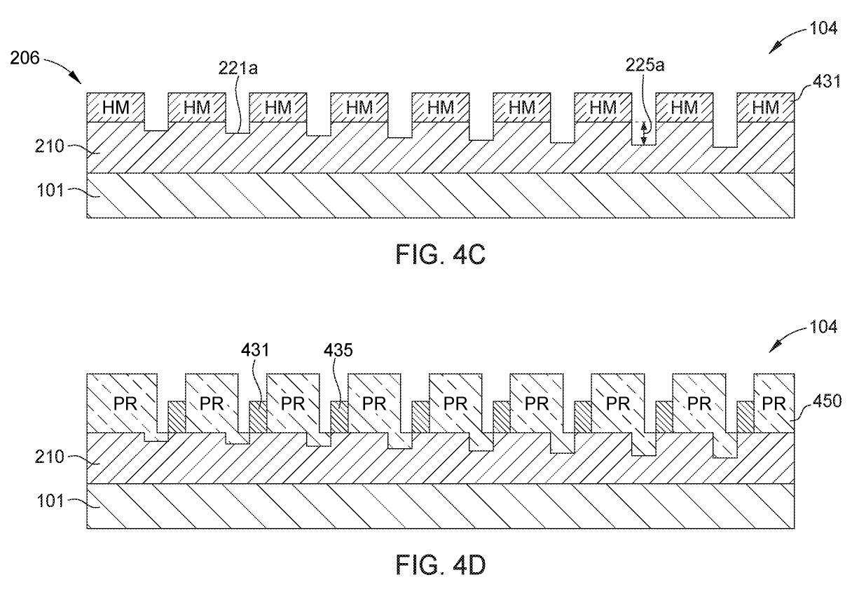

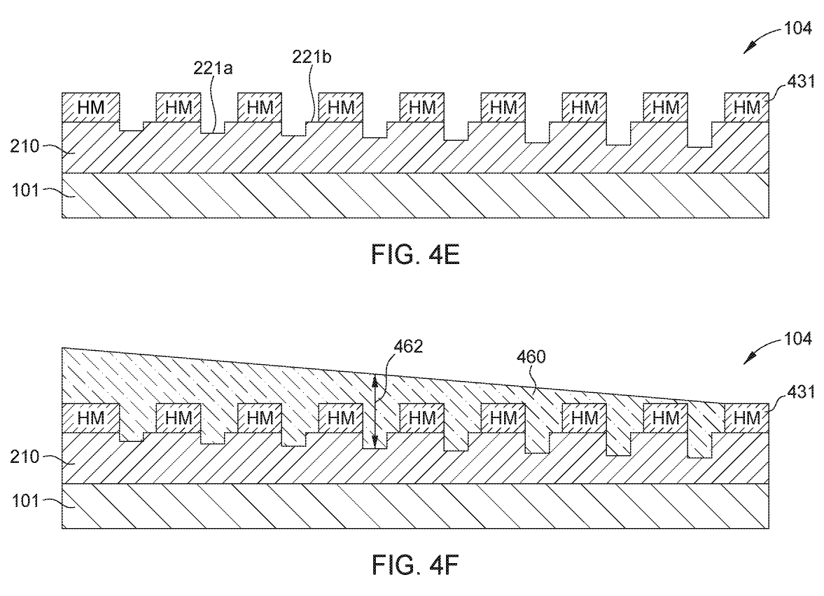

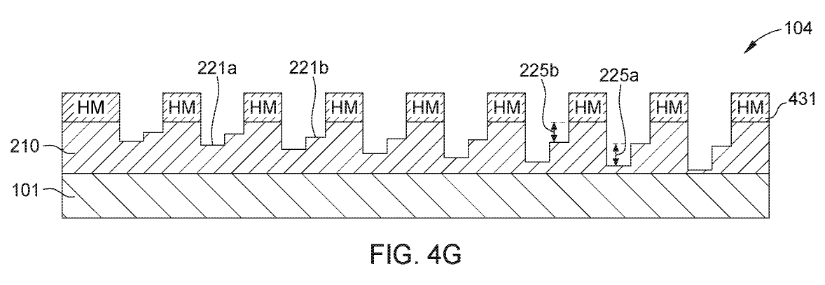

FIG. 3 illustrates a flow diagram of a method 300 of forming a grating 104 having two or more staircase structures 206, according to embodiments disclosed herein. FIGS. 4A-4G illustrate schematic, cross-sectional views of a substrate 101 during the method 300 of forming the grating 104 having two or more staircase structures 206 as illustrated in FIG. 3, according to embodiments disclosed herein.

At operation 302, a hardmask pattern 430 is formed, as shown in FIG. 4A. The hardmask pattern 430 is formed over the grating layer 210, which is formed over the substrate 101. The hardmask pattern 430 includes a plurality of hardmask portions 431. Each of the plurality of hardmask portions 431 are separated by a hardmask distance 432 to form gaps 433 disposed between each hardmask portion 431.

In one or more embodiments, the hardmask pattern 430 is formed from dielectric materials, metal‑containing materials, carbon‑containing materials, polymeric materials, or combinations thereof. Example hardmask materials include, but are not limited to, silicon dioxide, silicon nitride, silicon oxynitride, aluminum oxide, titanium oxide, chromium, titanium nitride, tantalum nitride, amorphous carbon, diamond‑like carbon, organic planarization layers, and polymer‑based hardmask materials.

The hardmask pattern 430 may be formed by forming a photoresist over the grating layer 210. The photoresist may be formed from a polymeric material. The photoresist may be formed by a lithography process. In one embodiment, the photoresist may be patterned using a lithography process to define the hardmask pattern 430 corresponding to locations of the structures 106 to be formed in the grating 104.

In some embodiments, the lithography process includes exposing grating lines in the photoresist and developing the photoresist to form a patterned photoresist layer. In one or more embodiments, the photoresist is formed using a graytone lithography process such that the photoresist defines a thickness variation to a variable depth blazed grating profile.

After patterning the photoresist, the photoresist is developed. After developing the photoresist over the grating layer 210, the photoresist is etched to form the hardmask pattern 430. In some embodiments, the patterned photoresist is removed after formation of the hardmask pattern 430. In other embodiments, at least a portion of the patterned photoresist remains during subsequent processing operations.

At operation 304, a first resist 440 is formed, as shown in FIG. 4B. The first resist 440 is formed over the hardmask pattern 430. The first resist 440 is formed in the gaps 433 between each hardmask portion 431. The first resist 440 includes a thickness 442 variation along the length of the grating layer 210. At one end of the grating layer 210, the thickness 442 of the first resist 440 is greater than the thickness 442 at the other end of the grating layer 210. The first resist 440 may have a thickness 442 greater than the thickness of the hardmask portions 431 such that the first resist 440 is formed over each of the hardmask portions 431.

In one or more embodiments, the resist 440 is formed from polymeric materials, organic planarization materials, carbon‑containing materials, or combinations thereof. Example resist materials include, but are not limited to, photoresist materials, organic planarization layers, spin‑on carbon materials, cross‑linked polymer layers, and multilayer resist stacks. In some embodiments, the resist functions as an etch‑modulating layer configured to define an etch profile having a thickness variation along a length of the grating layer 210.

The first resist 440 may be formed by similar patterning and lithography processes as described above when describing the formation of the hardmask pattern 430. In some embodiments, the first resist 440 is formed via a graytone lithography process to form a thickness 442 variation along the length of the grating layer 210.

At operation 306, a first etch process is performed, as shown in FIG. 4C. The first etch process is performed to etch the grating layer 210 through the first resist 440. The first etch process transfers the first etch profile defined by the first resist 440 into the grating layer 210 to form the first plurality of steps 221a in the grating layer 210. The first steps 221a are formed in a plurality of staircase structures 206 disposed along a length of the grating 104. In some embodiments, the depths 225a of each first step 221a are different. In some embodiments, the first depths 225a vary along the length of the grating 104 in accordance with the thickness variation of the first resist 440, such that different staircase structures 206 have different first depths 225a.

In some embodiments, the first etch process is a selective etch process configured to etch the grating layer 210 at a greater rate than the first resist 440 and the hardmask pattern 430. A greater etching rate in the grating layer 210 results in a greater first depth 225a. In these embodiments, the etch selectivity of the grating layer 210 is greater than the etch selectivity of the first resist 440 and the etch selectivity of the hardmask pattern 430. The ratio of the etch selectivity of the grating layer 210 to the etch selectivity of the first resist 440 or the hardmask pattern 430 may be from about 1:2 to about 1:100. In some embodiments, the ratio of oxygen gas may be adjusted to tune the etch selectivities.

At operation 308, a photoresist pattern 450 is formed, as shown in FIG. 4D. The photoresist pattern 450 is formed over the grating layer 210. The photoresist pattern 450 is formed over each hardmask portion 431 of the hardmask pattern 430. The photoresist pattern 450 is disposed over portions of each hardmask portion 431 such that the photoresist pattern 450 is not disposed over a plurality of exposed hardmask portions 435. The photoresist pattern 450 is formed in the first step 221a of each staircase structure 206. The photoresist pattern 450 includes photoresist portions disposed over the hardmask portions 431 and within the first steps 221, such that exposed hardmask portions 435 are exposed. The photoresist pattern 450 is formed by depositing a photoresist material and patterning the photoresist material using a lithography process as described above when referring to the formation of the hardmask pattern 430.

The photoresist pattern 450 may be formed from a polymeric, radiation‑sensitive material. Example photoresist materials include, but are not limited to, positive‑tone photoresists, negative‑tone photoresists, chemically amplified photoresists, epoxy‑based photoresists, polyhydroxystyrene‑based photoresists, and electron‑beam‑sensitive photoresists. In some embodiments, the photoresist is configured for graytone lithography or variable‑dose exposure such that the photoresist defines a thickness variation corresponding to a variable depth blazed grating profile.

At operation 310, the hardmask pattern 430 is etched, as shown in FIG. 4E. The exposed hardmask portions 435 are etched. The etching of the exposed hardmask portions 435 modifies the hardmask pattern 430 to expose the grating layer 210. In some embodiments, the etching of the exposed hardmask portions 435 is performed using a selective etch process configured to remove hardmask material at a greater rate than the photoresist pattern 450 and the grating layer 210. The ratio of the etch selectivity of the hardmask pattern 430 to the etch selectivity of the photoresist pattern 450 or the grating layer 210 may be from about 1:1 to about 1:20. In some embodiments, at operation 310, a binary etch process is performed such that enough hardmask pattern 430 remains with minimal etching of the grating layer 210.

In some embodiments, the photoresist pattern 450 is removed after etching the exposed hardmask portions 435 of the hardmask pattern 430. In other embodiments, at least a portion of the photoresist pattern 450 remains during subsequent processing operations.

At operation 312, a second resist 460 is formed, as shown in FIG. 4F. The second resist 460 is formed over the grating layer 210. The second resist 460 is formed over each hardmask portion 431. The second resist 460 is formed in the first steps 221a of each staircase structure 206. At one end of the grating layer 210, the thickness 462 of the second resist 460 is greater than the thickness 462 at the other end of the grating layer 210. The second resist 460 may have a thickness 462 greater than the thickness of the hardmask portions 431 such that the second resist 460 is formed over each of the hardmask portions 431.

The second resist 460 may be formed by similar patterning and lithography processes as described above when describing the formation of the hardmask pattern 430. In some embodiments, the second resist 460 is formed via a graytone lithography process to form a thickness 462 variation along the length of the grating layer 210. The second resist 460 may be made of the resist materials described above when referring to the first resist 440.

At operation 314, a second etch process is performed, as shown in FIG. 4G. The second etch process is performed to etch the grating layer 210 through the second resist 460. The second etch process transfers the second etch profile defined by the second resist 460 into the grating layer 210 to form the second plurality of steps 221b in the grating layer 210. The second steps 221b are formed in the plurality of staircase structures 206. In some embodiments, the depths 225b of each second step 221b are different. In some embodiments, the second depths 225b vary along the length of the grating 104 in accordance with the thickness variation of the second resist 460, such that different staircase structures 206 have different second depths 225b. The second etch process increases the first depths 225a of each of the first steps 221a. The increase in the first depths 225a may be the same as the second depths 225b.

In some embodiments, the second etch process is a selective etch process configured to etch the grating layer 210 at substantially the same rate as the second resist 460 is etched, and to minimize the etching of the hardmask pattern 430. When the maximum thickness of the second resist 460 is equal to the first depth 225a, an equivalent etching rate in the grating layer 210 and second resist 460 results in second depths 225b that are substantially the same as the first depths 225a.

In some embodiments, the second etch process is a selective etch process configured to etch the grating layer 210 at a slower rate than the second resist 460 and/or the hardmask pattern 430. A slower etching rate in the grating layer 210 results in a minimized impact of the second resist 460. The ratio of the etch selectivity of the grating layer 210 to the etch selectivity of the second resist 460 or the hardmask pattern 430 may be from about 1:2 to about 1:100, such as from about 1:10 to about 1:30.

The method 300 described with reference to FIGS. 4A-4G forms a grating 104 having a plurality of staircase structures 206. Each staircase structure 206 may include a plurality of steps 221 with different depths 225. The first etch process and the second etch process cooperate to form first steps 221a having first depths 225a and second steps 221b having second depths 225b in the grating layer 210, wherein the depths vary along the length of the grating 104 to approximate a variable depth blazed grating profile.

In some embodiments, the sequence of forming a resist, etching the grating layer to form steps, forming a photoresist pattern overlapping hardmask portions, etching exposed portions of the hardmask pattern, and forming a subsequent resist and etch profile is repeatable. The sequence may be repeated any number of times to form additional steps within each staircase structure 206, thereby increasing a total staircase depth and increasing the number of steps used to approximate the variable depth blazed grating.

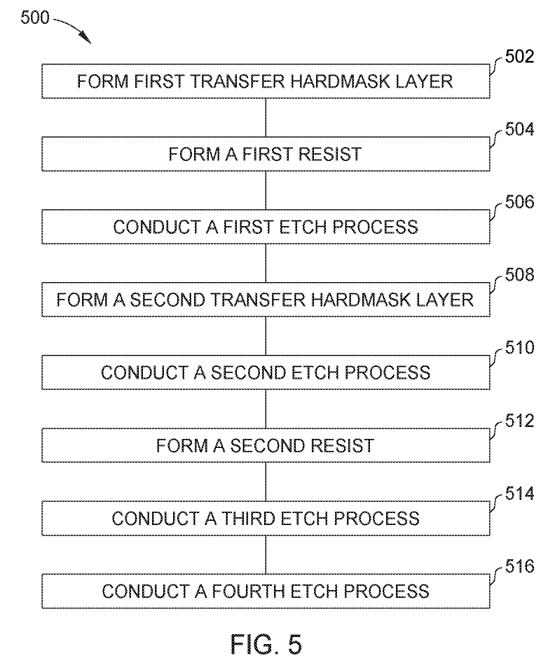

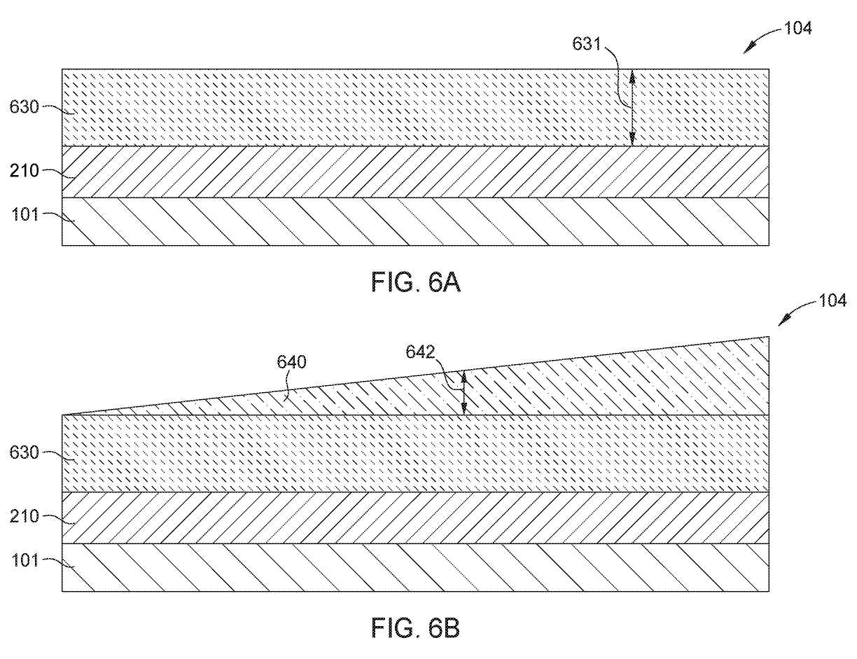

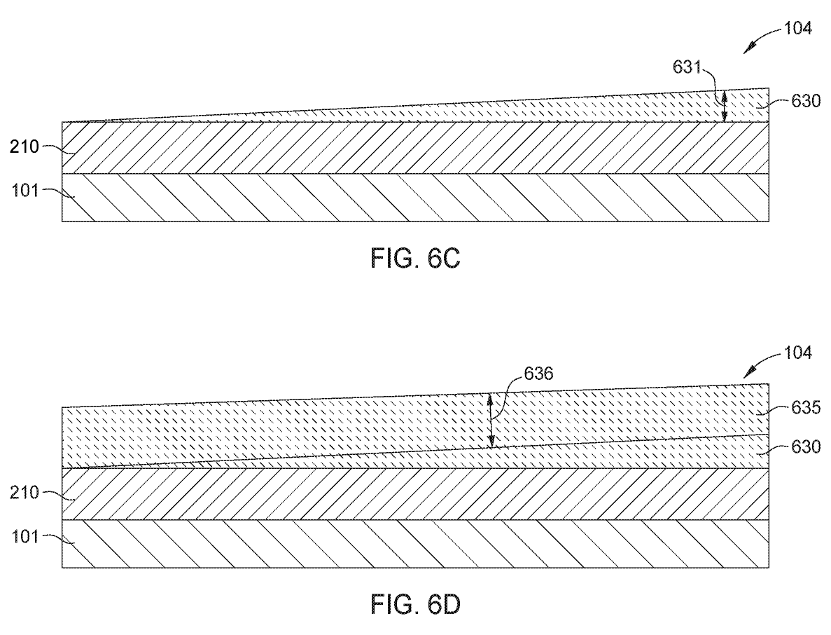

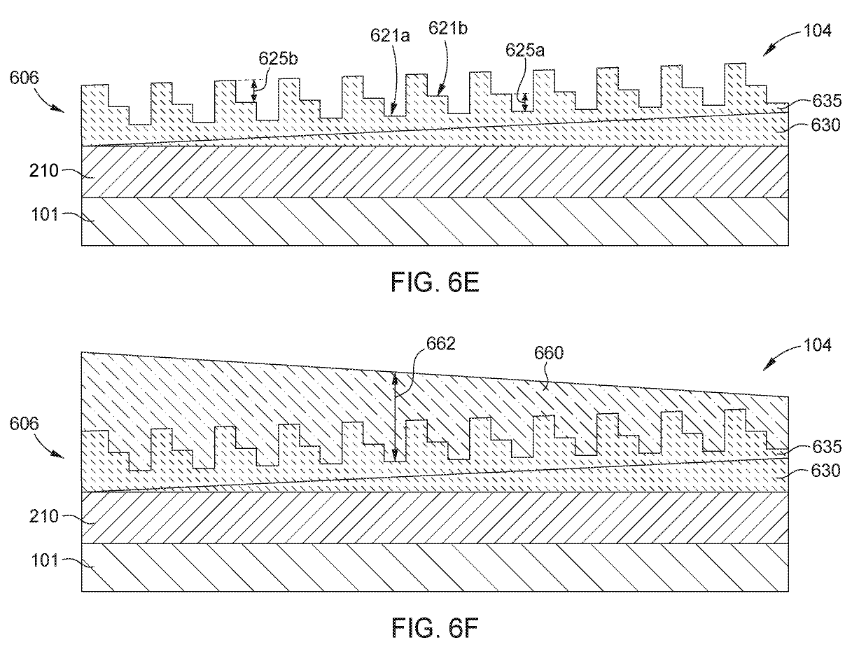

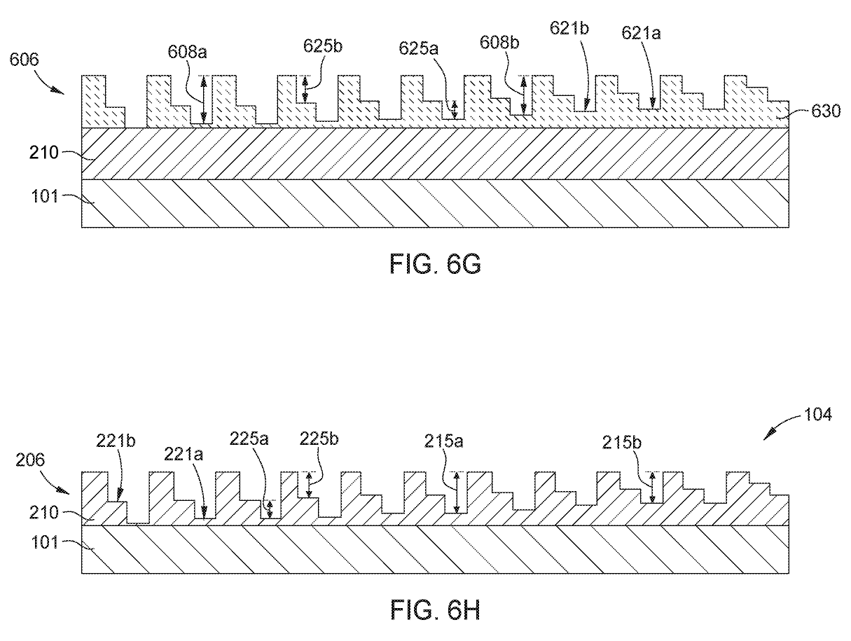

FIG. 5 illustrates a flow diagram of a method 500 of forming a grating 104 having two or more staircase structures 206, according to embodiments disclosed herein. FIGS. 6A-6H illustrate schematic, cross-sectional view of a substrate 101 during the method 500 of forming the grating 104 having two or more staircase structures 206 as illustrated in FIG. 5, according to embodiments disclosed herein.

At operation 502, a first transfer hardmask layer 630 is formed, as shown in FIG. 6A. The first transfer hardmask layer 630 is formed over the grating layer 210, which is formed over the substrate 101. The first transfer hardmask layer 630 is formed from a material selected to enable selective transfer of an etch profile into the grating layer 210. In some embodiments, the first transfer hardmask layer 630 is formed from the hardmask materials described above when referring to the hardmask pattern 430.

In one or more embodiments, the first transfer hardmask layer 630 is deposited as a substantially conformal layer over the grating layer 210. The first transfer hardmask layer 630 may be deposited using one or more thin-film deposition processes, including, but not limited to, chemical vapor deposition (CVD), plasma-enhanced chemical vapor deposition (PECVD), atomic layer deposition (ALD), physical vapor deposition (PVD), evaporation, sputtering, or spin-on deposition processes.

In some embodiments, the first transfer hardmask layer 630 is deposited to have a substantially uniform thickness 631 across the grating layer 210. In other embodiments, the thickness 631 of the first transfer hardmask layer 630 may vary based on deposition conditions or subsequent processing operations. The material and thickness 631 of the first transfer hardmask layer 630 may be selected to provide a desired etch selectivity relative to the first resist 640 and the grating layer 210, thereby enabling controlled transfer of a thickness-varying etch profile into the first transfer hardmask layer 630.

At operation 504, a first resist 640 is formed, as shown in FIG. 6B. The first resist 640 is formed over the first transfer hardmask layer 630. The first resist 640 is formed from a resist material selected to define a first etch profile for subsequent transfer into the first transfer hardmask layer 630. The first resist 640 includes a thickness 642 variation along a length of the grating layer 210 corresponding to a variable depth blazed grating.

In one or more embodiments, the first resist 640 is formed from a polymeric resist material, including photoresist materials, organic planarization materials, carbon-containing resist materials, combinations thereof, or other resist materials described above when referring to the method 300. The first resist 640 may be deposited using one or more deposition techniques, including, but not limited to, spin-on coating, spray coating, or other solution-based deposition processes.

In some embodiments, the first resist 640 is patterned using a lithography process to define the thickness variation of the first etch profile. The lithography process may include photolithography, graytone lithography, electron-beam lithography, laser-based patterning, or combinations thereof. In some embodiments, the first resist 640 is formed using a graytone lithography process such that the first resist 640 has a continuously or step-wise varying thickness 642 along the length of the grating layer 210.

In some embodiments, the thickness 642 and material composition of the first resist 640 are selected to provide a desired etch selectivity relative to the first transfer hardmask layer 630, thereby enabling controlled transfer of the first etch profile into the first transfer hardmask layer 630 during the subsequent etch process.

At operation 506, a first etch process is performed, as shown in FIG. 6C. The first etch process is performed to etch the first transfer hardmask layer 630 through the first resist 640. The first etch process transfers the first etch profile defined by the thickness 642 variation of the first resist 640 into the first transfer hardmask layer 630, thereby forming a thickness 631 variation in the first transfer hardmask layer 630 along the length of the grating layer 210.

In some embodiments, the first etch process is a selective etch process configured to etch the first transfer hardmask layer 630 at a greater rate than the first resist 640 and the grating layer 210. In these embodiments, the material and thickness of the first transfer hardmask layer 630 and the first resist 640 are selected to achieve controlled transfer of the thickness-varying etch profile into the first transfer hardmask layer 630. The etch selectivities and ratios of the components described in the method 300 may be equally attributed to the components described in method 500.

In some embodiments, the thickness 631 variation formed in the first transfer hardmask layer 630 corresponds to a variable depth blazed grating profile that will be further modified by subsequent processing operations. In some embodiments, the first transfer hardmask layer 630 is etched such that different regions along the length of the grating layer 210 have different remaining hardmask thicknesses.

At operation 508, a second transfer hardmask layer 635 is formed, as shown in FIG. 6D. The second transfer hardmask layer 635 is formed over the first transfer hardmask layer 630. The second transfer hardmask layer 635 is formed from a material selected to cooperate with the first transfer hardmask layer 630 to enable formation of staircase structures 206 in a subsequent etch process. The second transfer hardmask layer 635 may be made of the same material as the first transfer hardmask layer 630.

In one or more embodiments, the second transfer hardmask layer 635 is deposited as a substantially conformal layer over the first transfer hardmask layer 630. The second transfer hardmask layer 635 may be deposited using one or more thin‑film deposition processes, including, but not limited to, chemical vapor deposition (CVD), plasma‑enhanced chemical vapor deposition (PECVD), atomic layer deposition (ALD), physical vapor deposition (PVD), evaporation, sputtering, or spin‑on deposition processes.

In some embodiments, the second transfer hardmask layer 635 is deposited with a substantially uniform thickness 636 across the first transfer hardmask layer 630. In some embodiments, the second transfer hardmask layer 635 has a second hardmask etch selectivity that is different from the first hardmask etch selectivity of the first transfer hardmask layer 630. In other embodiments, the first hardmask etch selectivity is substantially equal to the second hardmask etch selectivity. The ratio of the etch selectivity of the second resist 460 etch selectivity to the etch selectivity of the second hardmask is from about 5:1 to about 1:2.

At operation 510, a second etch process is performed, as shown in FIG. 6E. The second etch process is performed to etch the first transfer hardmask layer 630 and/or the second transfer hardmask layer 635. The second etch process forms a plurality of hardmask structures 606 in the first transfer hardmask layer 630 and/or the second transfer hardmask layer 635.

In some embodiments, the plurality of hardmask structures 606 comprise staircase structures, wherein each hardmask structure 606 includes a first step 621a having a first depth 625a and a second step 621b having a second depth 625b different from the first depth 625a. The second etch process may be configured such that the first step 621a and the second step 621b of each hardmask structure 606 have substantially the same depths across the length of the grating layer 210.

In some embodiments, the second etch process is a selective etch process configured to etch the first transfer hardmask layer 630 and/or the second transfer hardmask layer 635 at a greater rate than the grating layer 210. The material composition and thickness of the first transfer hardmask layer 630 and the second transfer hardmask layer 635 may be selected to define the depths of the first and second steps formed in the hardmask staircase structures.

At operation 512, a second resist 660 is formed, as shown in FIG. 6F. The second resist 660 is formed over the plurality of hardmask structures 606 formed in the first transfer hardmask layer 630 and/or the second transfer hardmask layer 635. The second resist 660 is formed from a resist material selected to define a second etch profile for further modifying the hardmask structures 606.

The second resist 660 defines a thickness 662 variation along the length of the grating layer 210 corresponding to a variable depth blazed grating. In some embodiments, the thickness 662 variation of the second resist 660 is different from the thickness 642 variation of the first resist 640, such that the second etch profile is different from the first etch profile. In some embodiments, the second resist 660 has a greater thickness 662 at one end of the grating layer 210 and the first resist 640 has a greater thickness 642 at the other end of the grating layer 210.

In one or more embodiments, the second resist 660 is formed from polymeric resist materials, organic planarization materials, carbon-containing resist materials, or combinations thereof, and may be deposited using spin-on coating, spray coating, or other solution-based deposition processes. In some embodiments, the second resist 660 is patterned using a lithography process, including photolithography, graytone lithography, electron-beam lithography, laser-based patterning, or combinations thereof. In some embodiments, the second resist 660 is formed using a graytone lithography process.

At operation 514, a third etch process is performed, as shown in FIG. 6G. The third etch process is performed to etch the hardmask structures 606 through the second resist 660. The third etch process modifies the plurality of hardmask structures 606 such that the depths 625a, 625b of corresponding steps 621a, 621b in the hardmask structures 606 are different from one another along the length of the grating layer 210. These depth 625a, 625b differences are subsequently transferred into the grating layer 210 during a later etch process.

In some embodiments, the third etch process is a selective etch process configured to etch the first transfer hardmask layer 630 and/or the second transfer hardmask layer 635 at a rate different from the second resist 660. The depth 608 of each modified hardmask structure 606 may be controlled by a ratio between the etch selectivity of the second resist 660 and the etch selectivity of the first transfer hardmask layer 630 and/or the second transfer hardmask layer 635. For example, at the beginning the etch rate of resist is faster but close to etch rate of 635/630. At the end of the etch process, the etch rate of resist is much faster than the etch rate 635/630. This etch selectivity change increases the staircase depths 625 along the length of the grating layer 210.

In some embodiments, the third etch process results in hardmask structures 606 having first depths 608a and second depths 608b that vary along the length of the grating layer 210, thereby forming a plurality of hardmask staircase structures 606 with different depths 608. These depth 608 differences are subsequently transferred into the grating layer 210 during a later etch process.

At operation 516, a fourth etch process is performed, as shown in FIG. 6H. The fourth etch process etches the device layer 210 through the plurality of hardmask structures 606 formed in the first transfer hardmask layer 630 and/or the second transfer hardmask layer 635. The fourth etch process transfers the staircase profiles defined in the hardmask structures 606 into the grating layer 210 to form a plurality of grating structures 206 having different structure depths 215a, 215b and step depths 225a, 225b along the length of the grating 104.

In some embodiments, the fourth etch process forms two or more steps 221a, 221b in each grating structure 206, wherein the steps 221a, 221b have different depths 225a, 225b and collectively define a staircase structure in the grating layer 210. In some embodiments, the different structure depths 215a, 215b vary along the length of the grating 104 in accordance with the depth variation defined in the hardmask structures 606, such that the grating structures 206 approximate a variable depth blazed grating profile.

In some embodiments, the fourth etch process is a selective etch process that occurs before operation 512. The fourth etch process is configured to etch the grating layer 210 more than the first transfer hardmask layer 630 and/or the second transfer hardmask layer 635. In these embodiments, variable depths are etched into the grating layer 210. In these embodiments, operations 512 and 514 are optional because the variable steps 221 are formed by tuning the etch selectivities of the grating layer 210 as it relates to the first transfer hardmask layer 630 and/or the second transfer hardmask layer 635.

The method 500 described with reference to FIGS. 6A–6H forms a grating 104 having a plurality of grating structures 206 with different structure depths 215 along the length of the grating 104. The method 500 utilizes one or more transfer hardmask layers 630, 635 and one or more resist layers 640, 660 to define etch profiles that are selectively transferred into the grating layer 210 through a sequence of etch processes. The resulting grating structures 206 include a plurality of staircase structures, wherein each staircase structure comprises two or more steps 221 having different depths 225.

In some embodiments, depth differentiation of the grating structures 206 is achieved by transferring thickness‑varying etch profiles into one or more transfer hardmask layers 630, 635 and subsequently transferring the staircase profiles into the grating layer 210. In other embodiments, depth differentiation is achieved by tuning etch selectivities between the grating layer 210, one or more transfer hardmask layers, and one or more resist layers 640, 660. In these embodiments, variable structure depths may be formed with or without performing multiple lithography processes.

In some embodiments, the sequence of forming a transfer hardmask layer, forming a resist defining an etch profile, etching the transfer hardmask layer, and etching the grating layer is repeatable. The sequence may be repeated any number of times to form additional steps within each staircase structure, thereby increasing the total structure depth and increasing the number of steps used to approximate a variable depth blazed grating profile.

The embodiments disclosed herein provide robust techniques for forming gratings with precisely controlled, non‑uniform structure depths that approximate a variable depth blazed profile. By enabling independent control of step depth, total structure depth, and depth variation along a grating length, the disclosed approaches support high diffraction efficiency, improved optical uniformity, and enhanced performance across a field of view. The methods allow formation of staircase structures having two or more steps and are repeatable to achieve increased depth resolution without requiring a proportional increase in lithography complexity. Further, the use of selectable resist profiles, transfer hardmask layers, and tunable etch selectivities provides flexibility to adapt the fabrication process to different materials, device architectures, and manufacturing constraints. As a result, the disclosed techniques are well‑suited for scalable fabrication of advanced optical components, including waveguide combiners for augmented‑reality and related display applications.

The preceding discussion is directed to various embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

Any one or more components of the various embodiments disclosed herein may be integrally formed together, directly coupled together, and/or indirectly coupled together and are not limited to the specific arrangement of components illustrated in FIGS. 1-6H. Any one or more of the components, embodiments, or steps of the embodiments disclosed herein may be combined in whole or part with any other components, embodiments, or steps of the embodiments disclosed herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below.

In the preceding discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections.

Certain embodiments and features have been described using the term “about,” “generally,” “substantially,” and/or “generally.” When any of these terms are used in conjunction with a numerical value, it should be construed as indicating any numerical value within 10% of the stated numerical value.

While the foregoing is directed to embodiments of the present disclosure, other and further embodiments of the disclosure may be devised without departing from the basic scope thereof, and the scope thereof is determined by the claims that follow.

What is claimed is:

1. A method of forming a variable depth blazed grating, comprising:
forming a hardmask pattern over a grating layer, the hardmask pattern having hardmask portions;
forming a first resist over the hardmask pattern and the grating layer, the first resist having a first etch profile with a thickness variation along a length of the grating layer corresponding to the variable depth blazed grating;
etching the grating layer to form first steps having first depths in the grating layer, wherein at least two of the first depths are different;
forming a photoresist pattern over the grating layer, the photoresist pattern having photoresist portions that are disposed over the hardmask portions and in the first steps, wherein first portions of each hardmask portion are exposed;
etching the first portions of each hardmask portion;
forming a second resist over the hardmask pattern and the grating layer, the second resist having a second etch profile with a second thickness variation along the length of the grating layer corresponding to the variable depth blazed grating; and
etching the grating layer to form second steps having second depths in the grating layer, wherein at least two of the second depths are different and the first depths of the first steps are increased.

2. The method of claim 1, further comprising removing each hardmask portion of the hardmask pattern.

3. The method of claim 1, further comprising:
forming a second photoresist pattern over the grating layer, the second photoresist pattern having photoresist portions that are disposed over the hardmask portions and in the first steps and the second steps, wherein second portions of each hardmask portion are exposed;
etching the second portions of each hardmask portion;
forming a third resist over the hardmask pattern and the grating layer; and
etching the grating layer to form third steps having third depths in the grating layer, at least two of the third depths are different and the first depths and the second depths are increased.

4. The method of claim 3, wherein forming the photoresist pattern over the grating layer, etching exposed portions of each hardmask portion, forming the resist over the hardmask pattern and the grating layer, and etching the grating layer are repeated to form additional steps and increase depths of the steps of the variable depth blazed grating.

5. The method of claim 1, wherein the first resist, the second resist, or both are formed via a graytone lithography process.

6. The method of claim 1, wherein a ratio of the first depth to the second depth is from about 2:1 to about 1:2.

7. The method of claim 1, wherein a ratio of the first depth of the first step of a first structure to the first depth of the first step of a second structure is from about 2:1 to about 1:25.

8. The method of claim 1, wherein a ratio of a structure depth of a first structure to a structure depth of a second structure is from about 4:1 to about 1:4.

9. A method of forming a variable depth blazed grating, comprising:
forming a first hardmask layer over a grating layer, the first hardmask layer having a first hardmask etch selectivity and the grating layer having a grating layer etch selectivity;
forming a first resist over the first hardmask layer, the first resist having a first resist etch selectivity and a first etch profile with a thickness variation along a length of the grating layer corresponding to the variable depth blazed grating;
etching the first hardmask layer to form a thickness variation in the first hardmask layer along the length of the grating layer;
forming a second hardmask layer over the first hardmask layer, the second hardmask layer having a uniform thickness and a second hardmask etch selectivity;
etching the first hardmask layer, the second hardmask layer, or both to form a plurality of hardmask structures, the hardmask structures comprising a first step having a first depth and a second step having a second depth; and
etching the grating layer to form a plurality of structures in the grating layer, the structures comprising the first step having the first depth and the second step having the second depth.

10. The method of claim 9, further comprising:
forming a second resist over the plurality of hardmask structures and in the
first steps and the second steps of the plurality of hardmask structures, the second resist having a second resist etch selectivity and a second etch profile with a thickness variation along the length of the grating layer corresponding to the variable depth blazed grating; and
etching the plurality of hardmask structures such that the first depth of each first step is different.

11. The method of claim 10, wherein the thickness variation of the first etch profile has a greater thickness at a first end of the grating layer and the thickness variation of the second etch profile has a greater thickness at a second end of the grating layer.

12. The method of claim 10, wherein the first depth and the second depth are increased by increasing a ratio between the grating layer etch selectivity and the first hardmask etch selectivity or the second hardmask etch selectivity.

13. The method of claim 10, wherein the second etch profile is different from the first etch profile.

14. The method of claim 9, wherein the first resist and/or the second resist are formed via a graytone lithography process.

15. The method of claim 9, wherein the first hardmask etch selectivity is substantially equal to the second hardmask etch selectivity.

16. The method of claim 9, wherein a ratio of the second hardmask etch selectivity to the grating layer etch selectivity is from about 1:1.5 to about 1:20.

17. The method of claim 10, wherein a ratio of the second resist etch selectivity to the second hardmask etch selectivity is from about 5:1 to about 1:2.

18. The method of claim 9, wherein a ratio of the first hardmask etch selectivity to the grating layer etch selectivity is from about 2:3 to about 1:20.

19. The method of claim 9, wherein etching the grating layer forms structures having different structure depths along the length of the grating layer as a result of thickness variations in the first hardmask layer.

20. A waveguide, comprising:
a substrate;
a grating layer disposed over the substrate;
a grating formed in or on the grating layer, the grating comprising a plurality of structures, each structure comprising:
a structure depth different from each other structure;
a first step having a first depth, the first depth of a first structure different than the first depth of a second structure; and
a second step having a second depth different from the first depth, the second depth of the first structure different than the second depth of the second structure and wherein the first step and the second step approximate a variable depth blazed profile.
